(19) United States
(12) Patent Application Publication
(10) Pub. No.: US 2014/0068417 A1
(43) Pub. Date: Mar. 6, 2014

(54) Script Processing Method and System for Browsers

(71) Applicant: TENCENT TECHNOLOGY (SHENZHEN) COMPANY LIMITED, Shenzhen (CN)

(72) Inventor: Baohua Zhang, Shenzhen (CN)

(21) Appl. No.: 14/051,230

(22) Filed: Oct. 10, 2013

Related U.S. Application Data
(63) Continuation of application No. PCT/CN2012/072452, filed on Mar. 16, 2012.

(30) Foreign Application Priority Data
Apr. 19, 2011 (CN) 201110097899X

(51) Int. Cl. G06F 17/22

(52) U.S. Cl. CPC G06F 17/2247
USPC 715/234

(57) ABSTRACT

The disclosure provides a script processing method and system for a browser. The method includes: a client transmitting to a proxy server a Uniform Resource Locator (URL) requested by a user; the proxy server requesting a page from an Internet server corresponding to the URL, compiling a script code of the page returned from the Internet server into a binary bytecode, and transmitting the binary bytecode to the client; and the client executing the binary bytecode. The disclosure effectively reduces the overhead of script code compilation on a mobile terminal browser, thereby enabling the mobile terminal browser to support the execution of script code.

### CROSS REFERENCE TO RELATED APPLICATIONS

This is a continuation application of International Patent Application No.: PCT/CN2012/072452, filed on Mar. 16, 2012, which claims priority to Chinese Patent Application No.: 201110097899.X, filed on Apr. 19, 2011, the disclosure of which is incorporated by reference herein in its entirety.

### TECHNICAL FIELD

The disclosure relates to a terminal browser technology of Internet, and in particular to a script processing method and a script processing system for a browser.

### BACKGROUND

At present, the execution of JavaScript codes in a webpage needs to include the following steps on a standard Personal Computer (PC) browser.

1. The browser on the PC compiles the JavaScript source code and converts the JavaScript source code into a binary bytecode that can be used by a JavaScript virtual machine.

2. The JavaScript virtual machine on the browser executes the corresponding binary bytecode.

The JavaScript is a common scripting language in present browsers.

The execution of JavaScript codes on the PC browser has a high requirement on the processing capability of Central Processing Unit (CPU) and the size of memory space. However, the present mobile terminal (for example, mobile phone) is seriously limited in both the processing capability of CPU and the size of memory space. Therefore, most mobile terminals cannot meet the requirement of JavaScript code execution on the PC browser, which makes it difficult to apply the JavaScript code execution on the PC browser to mobile terminals. The prior art fails to provide a solution to the above technical problems, which causes inconveniences in actual application.

### SUMMARY

In view of the above, the main purpose of the disclosure is to provide a script processing method and a script processing system for a browser, to enable the browser of a mobile terminal to support the execution of JavaScript.

To achieve the purpose above, the disclosure provides the following technical solutions.

The disclosure provides a script processing method for a browser, which includes:

receiving, by a proxy server, a Uniform Resource Locator (URL) transmitted from a client; and requesting, by the proxy server, a page from an Internet server corresponding to the URL, compiling a script code of the page returned from the Internet server into a binary bytecode, and transmitting the binary bytecode to the client.

The method may further include:

receiving, by the proxy server, a Hypertext Markup Language (HTML) file of the page returned from the Internet server after requesting the page from the Internet server, converting the HTML file of the page into a binary Document Object Model (DOM) tree structure, and transmitting the DOM tree structure to the client.

After the proxy server transmits the DOM tree structure to the client, the method may further include:

rendering, by the client, content of the DOM tree structure on the page.

The script code may be JavaScript code or VBScript code.

The disclosure further provides a script processing method for a browser, which includes:

transmitting, by a client. a Uniform Resource Locator (URL) requested by a user to a proxy server; and

receiving, by the client, a binary bytecode transmitted by the proxy server, and executing the binary bytecode; wherein the binary bytecode is obtained by the proxy server by requesting a page from an Internet server corresponding to the URL and compiling the script code of the page returned from the Internet server.

After the client transmits the URL to the proxy server, the client receives a DOM tree structure transmitted by the proxy server and renders the content of the DOM tree structure on the page, wherein the DOM tree structure is obtained by the proxy server by converting a HTML file of the page returned from the Internet server.

The disclosure further provides a script processing system for a browser, which includes a client, a proxy server and an Internet server.

The client is configured to transmit a Uniform Resource Locator (URL) requested by a user to the proxy server and to execute a binary bytecode returned from the proxy server.

The proxy server is configured to request a page from the Internet server corresponding to the URL, to compile the script code of the page returned from the Internet server into a binary bytecode, and to transmit the binary bytecode to the client; and

the Internet server is configured to provide the script code of the page to the proxy server according to a request from the proxy server.

The Internet server is further configured to transmit a Hypertext Markup Language (HTML) file of the page to the proxy server after receiving the page request from the proxy server.

The proxy server is further configured to convert the HTML file of the page into a binary DOM tree structure and to transmit the DOM tree structure to the client.

The client is further configured to render the content of the DOM tree structure on the page after receiving the DOM tree structure from the proxy server.

The script code may be a JavaScript code or VBScript code.

The disclosure further provides a proxy server, which includes: a Uniform Resource Locator (URL) receiving module, a page request module, and a compiling and transmitting module.

The URL receiving module is configured to receive a URL from a client and to notify the page request module.

The page request module is configured to request a page from an Internet server corresponding to the URL.

The compiling and transmitting module is configured to compile the script code of the page returned from the Internet server into a binary bytecode and to transmit the binary bytecode to the client.

The compiling and transmitting module is further configured to: receive a HTML file of the page returned from the Internet server after the page request module requests a page from the Internet server, convert the HTML file of the page into a binary DOM tree structure, and transmit the binary DOM tree structure to the client.

The script code may be a JavaScript code or VBScript code.

The disclosure further provides a client, which includes: a Uniform Resource Locator (URL) transmitting module, and a receiving and executing module.

The URL transmitting module is configured to transmit a URL requested by a user to a proxy server.

The receiving and executing module is configured to: receive a binary bytecode transmitted by the proxy server and execute the binary bytecode. The binary bytecode is obtained by the proxy server by requesting a page from an Internet server corresponding to the URL and compiling the script code of the page returned from the Internet server.

The receiving and executing module is further configured to: receive a DOM tree structure transmitted by the proxy server after the URL transmitting module transmits the URL, and render content of the DOM tree structure on the page. The DOM tree structure is obtained by the proxy server by converting a HTML file of the page returned from the Internet server.

With the script processing method and the script processing system for a browser provided by the disclosure, the compilation and the execution of the browser script code are conducted separately, which is that the browser script code is compiled into a binary bytecode on the proxy server before being transmitted to the browser client of the mobile terminal, and the browser client of the mobile terminal execute the binary bytecode compiled by the proxy server directly. The disclosure effectively reduces the overhead of script code compilation on the mobile terminal browser, thereby enabling the mobile terminal browser to support the execution of script code.

### BRIEF DESCRIPTION OF THE DRAWINGS

FIG. 1 shows a flowchart of a script processing method for a browser in the disclosure;

FIG. 2 shows a structure diagram of a script processing system for a browser in the disclosure; and

FIG. 3 shows a diagram of script processing on a browser in an embodiment of the disclosure.

### DETAILED DESCRIPTION

The technical solution of the disclosure is illustrated below in more detail in conjunction with accompanying drawings and specific embodiments.

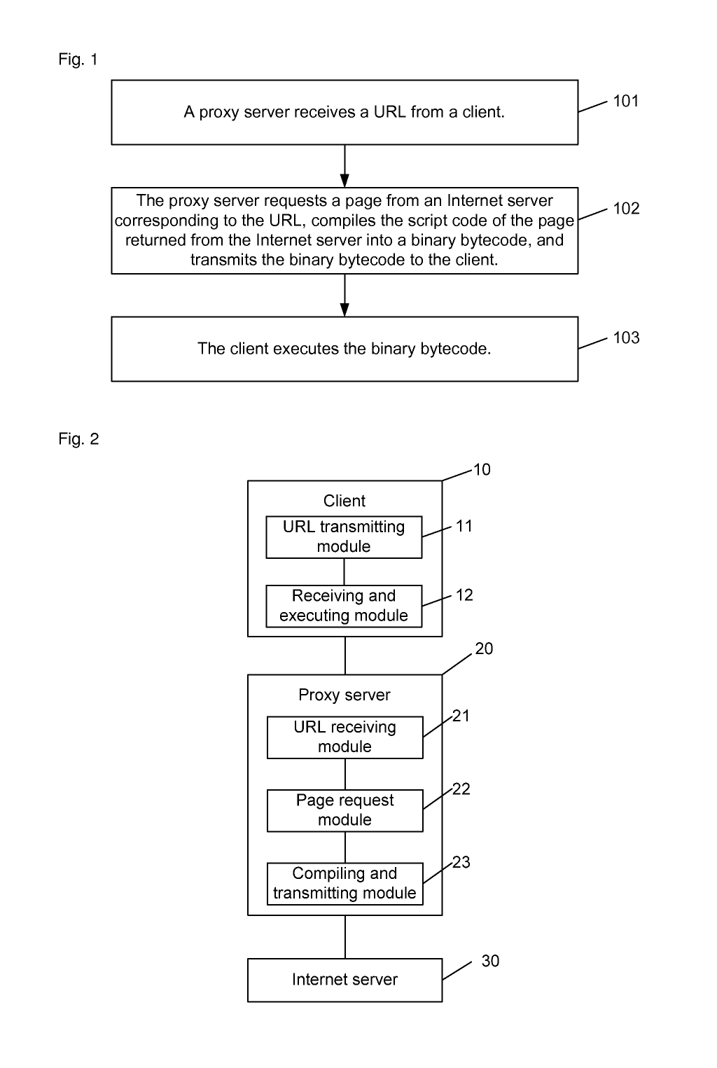

To enable the browser of a mobile terminal to support the execution of script codes (e.g., JavaScript), the disclosure provides a script processing method for a browser. As shown in FIG. 1, the method includes the following steps:

Step 101: A proxy server receives a Uniform Resource Locator (URL) transmitted from a client.

The client transmits the URL requested by a user to the proxy server.

When accessing a website, a user may click or input an address (i.e., URL) of the needed website on a browser client of a mobile terminal used by the user. Then, the browser client of the mobile terminal records the URL clicked or input by the user and transmits the recorded URL to the proxy server.

Step 102: The proxy server requests a page from an Internet server corresponding to the URL, compiles a script code of the page returned from the Internet server into a binary bytecode, and transmits the binary bytecode to the client.

After the proxy server receives the URL transmitted by the client, the proxy server finds an Internet server corresponding to the URL and transmits a page request to the Internet server. After the Internet server receives the page request from the proxy server, the Internet server returns the script code of the corresponding page to the proxy server. The proxy server compiles the script code of the page returned from the Internet server into a binary bytecode that can be used by a JavaScript virtual machine of the browser client, and transmits the binary bytecode to the client.

Step 103: The client executes the received binary bytecode.

After the client receives the binary bytecode returned from the proxy server, the client executes the corresponding binary bytecode through the JavaScript virtual machine.

It should be noted that the Internet server needs to transmit a Hypertext Markup Language (HTML) file of the page to the proxy server after receiving the page request from the proxy server, then the proxy server converts the HTML file of the page into a binary DOM tree structure and transmits the DOM tree structure to the client, and finally the client renders the content of the DOM tree structure on the page.

Corresponding to the script processing method for a browser, the disclosure also provides a script processing system for the browser. As shown in FIG. 2, the system includes: a client 10, a proxy server 20 and an Internet server 30. The client 10 is configured to transmit a URL requested by a user to the proxy server 20 and to execute a binary bytecode returned from the proxy server 20. The proxy server 20 is configured to request a page from the Internet server 30 corresponding to the URL, to compile a script code of the page returned from the Internet server 30 into a binary bytecode, and to transmit the binary bytecode to the client 10. The Internet server 30 is configured to provide the script code of the page to the proxy server 20 according to a request from the proxy server 20.

Preferably, the Internet server 30 is further configured to transmit a HTML file of the page to the proxy server 20 after receiving the page request from the proxy server 20.

Correspondingly, the proxy server 20 is further configured to convert the HTML file of the page into a binary DOM tree structure and to transmit the DOM tree structure to the client 10.

The client 10 is further configured to render the content of the DOM tree structure on the page after receiving the DOM tree structure from the proxy server 20.

The proxy server 20 includes: a URL receiving module 21, a page request module 22, and a compiling and transmitting module 23. The URL receiving module 21 is configured to receive a URL from a client and to notify the page request module 22. The page request module 22 is configured to request a page from an Internet server corresponding to the URL. The compiling and transmitting module 23 is configured to compile the script code of the page returned from the Internet server into a binary bytecode and to transmit the binary bytecode to the client.

Preferably, the compiling and transmitting module 23 is further configured to: receive a HTML file of the page returned from the Internet server after the page request module 22 requests a page from the Internet server, convert the HTML file of the page into a binary DOM tree structure, and transmit the binary DOM tree structure to the client.

The client 10 includes: a URL transmitting module 11, and a receiving and executing module 12. The URL transmitting module 11 is configured to transmit a URL requested by a user to a proxy server. The receiving and executing module 12 is configured to receive a binary bytecode transmitted by the proxy server and execute the binary bytecode. The binary bytecode is obtained by the proxy server by requesting a page from an Internet server corresponding to the URL and compiling the script code of the page returned from the Internet server.

The receiving and executing module 12 is further configured to: receive a DOM tree structure transmitted by the proxy server after the URL transmitting module 11 transmits the URL, and render the content of the DOM tree structure on the page. The DOM tree structure is obtained by the proxy server by converting a HTML file of the page returned from the Internet server.

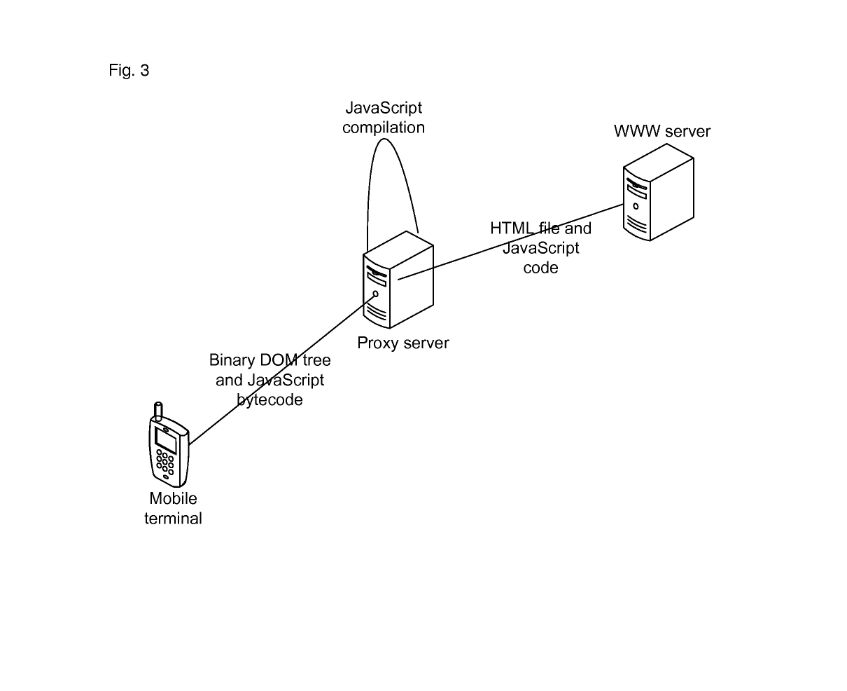

The script processing method and the script processing system for a browser provided by the disclosure are described below in more detail in conjunction with the embodiment shown in FIG. 3.

As shown in FIG. 3, the user of a mobile terminal clicks a World Wide Web (WWW) page link through a browser. Then, the browser client of the mobile terminal records the URL of the WWW page link and transmits the recorded URL to a background proxy server. After the proxy server receives the URL transmitted from the client, the proxy server finds a WWW server corresponding to the URL and transmits a page request to the WWW server. After the WWW server receives the page request from the proxy server, the WWW server returns to the proxy server a HTML file and a script code of the corresponding page. Then, the proxy server converts the HTML file of the page into a binary DOM tree structure, complies the script code of the page into a binary bytecode that can be used by the JavaScript virtual machine of the browser client, and transmits the binary DOM tree structure and the binary bytecode to the client. After the client receives the binary DOM tree structure and the binary bytecode returned from the proxy server, the client renders the content of the DOM tree structure on the page and executes the corresponding binary bytecode through the JavaScript virtual machine.

For example, the WWW server transmits the following HTML file to the proxy server:

<html>
<body>
hello,world!
</br>
<img src=“./4.jpg” width=“130” height=“130”>
</body>
</html>

The complied binary DOM tree structure is shown in Table 1:

TABLE 1

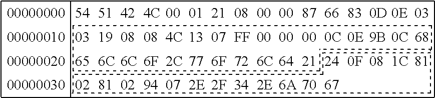

In Table 1, data “54 51 42 4C 00 01 21 08 00 00 87 66 83 OD OE 03” represents a file header, the data in the upper dotted box is the binary code data of “hello, world!”, and the data in the lower dotted box is the binary code data of the image in the img label.

Taking the image in the img label for example, the specific definition is described in Table 2.

TABLE 2

| Position | Length | | |
|---|---|---|---|
| Offset | (Byte) | Value | Definition |
| 00 | 1 | 0x24 | tagID represents that this is |
| | | | an image img label |
| 01 | 1 | 0x0f | The length of the data |
| | | | contained in this tag |
| 02 | 1 | 0x08 | Horizontal coordinate for |
| | | | showing image |
| 03 | 1 | 0x1c | Longitudinal coordinate for |
| | | | showing image |
| 04 | 2 | 0x81 0x02 | Width for showing image |
| 06 | 2 | 0x81 0x02 | Height for showing image |
| 08 | 1 | 0x94 | Image file name ID |
| 09 | 1 | 0x07 | Character string length of |
| | | | image file name |
| 10 | 7 | 0x2e 0x2f 0x34 0x2e | Character string of image file |
| | | 0x6a 0x70 0x67 | name |

When the client receives the binary data shown in Table 1 and performs rendering, the client draws the image at a proper position on the screen of the client according to the coordinate data and image size data provided in Table 2, to complete the rendering process, without computing the coordinate position for placing the image. Thus, the computation load of the client is reduced.

To sum up, the compilation and the execution of the browser script code are conducted separately in the disclosure, which is that the browser script code is compiled into a binary bytecode on the proxy server before being transmitted to the browser client of the mobile terminal, and the browser client of the mobile terminal directly executes the binary bytecode compiled by the proxy server. With such process, the overhead of script code compilation on the mobile terminal browser is reduced, and the mobile terminal browser is enabled to support the execution of script code. It should be noted that the script processing method and the script processing system for a browser provided by the disclosure are not only suitable for the processing of JavaScript code, but also suitable for the processing of VBScript code. Since the processing of VBScript code is similar to the processing of JavaScript code, no further description is needed here.

The above are the preferred embodiments of the disclosure only and are not intended to limit the protection scope of the disclosure.

1. A script processing method for a browser, comprising:
receiving, by a proxy server, a Uniform Resource Locator (URL) from a client; and
requesting, by the proxy server, a page from an Internet server corresponding to the URL, compiling a script code of the page returned from the Internet server into a binary bytecode, and transmitting the binary bytecode to the client.

2. The method according to claim 1, further comprising:
receiving, by the proxy server, a Hypertext Markup Language (HTML) file of the page returned from the Internet server after requesting the page from the Internet server, converting the HTML file of the page into a binary Document Object Model (DOM) tree structure, and transmitting the DOM tree structure to the client.

3. The method according to claim 2, further comprising a step, after the proxy server transmits the DOM tree structure to the client, of:
rendering, by the client, content of the DOM tree structure on the page.

4. The method according to claim 1, wherein the script code is a JavaScript code or a VBScript code.

5. A script processing method for a browser, comprising:
transmitting, by a client, a Uniform Resource Locator (URL) requested by a user to a proxy server; and
receiving, by the client, a binary bytecode transmitted by the proxy server, and executing the binary bytecode; wherein the binary bytecode is obtained by the proxy server by requesting a page from an Internet server corresponding to the URL and then compiling a script code of the page returned from the Internet server.

6. The method according to claim 5, further comprising a step, after the client transmits the URL to the proxy server, of: receiving, by the client, a DOM tree structure transmitted by the proxy server and rendering content of the DOM tree structure on the page; wherein the DOM tree structure is obtained by the proxy server by converting a Hypertext Markup Language (HTML) file of the page returned from the Internet server.

7. A script processing system for a browser, comprising: a client, a proxy server and an Internet server, wherein
the client is configured to transmit to the proxy server a Uniform Resource Locator (URL) requested by a user and to execute a binary bytecode returned from the proxy server;
the proxy server is configured to request a page from the Internet server corresponding to the URL, to compile a script code of the page returned from the Internet server into a binary bytecode, and to transmit the binary bytecode to the client; and
the Internet server is configured to provide the script code of the page to the proxy server according to a request from the proxy server.

8. The system according to claim 7, wherein the Internet server is further configured to transmit a Hypertext Markup Language (HTML) file of the page to the proxy server after receiving the page request from the proxy server.

9. The system according to claim 7, wherein the proxy server is further configured to convert the HTML file of the page into a binary DOM tree structure and to transmit the DOM tree structure to the client.

10. The system according to claim 9, wherein the client is further configured to render content of the DOM tree structure on the page after receiving the DOM tree structure from the proxy server.

11. The system according to claim 7, wherein the script code is JavaScript code or VBScript code.

12. A proxy server, comprising: a Uniform Resource Locator (URL) receiving module, a page request module, and a compiling and transmitting module, wherein
the URL receiving module is configured to receive a URL from a client and to notify the page request module;
the page request module is configured to request a page from an Internet server corresponding to the URL; and
the compiling and transmitting module is configured to compile a script code of the page returned from the Internet server into a binary bytecode and to transmit the binary bytecode to the client.

13. The proxy server according to claim 12, wherein the compiling and transmitting module further configured to: receive a Hypertext Markup Language (HTML) file of the page returned from the Internet server after requesting a page from the Internet server, convert the HTML file of the page into a binary DOM tree structure, and transmit the binary DOM tree structure to the client.

14. The proxy server according to claim 12, wherein the script code is a JavaScript code or a VBScript code.

15. A client, comprising: a Uniform Resource Locator (URL) transmitting module, and a receiving and executing module, wherein
the URL transmitting module is configured to transmit a URL requested by a user to a proxy server;
the receiving and executing module is configured to receive a binary bytecode transmitted by the proxy server and execute the binary bytecode, wherein the binary bytecode is obtained by the proxy server by requesting a page from an Internet server corresponding to the URL and compiling a script code of the page returned from the Internet server.

16. The client according to claim 15, wherein the receiving and executing module is further configured to: receive a DOM tree structure transmitted by the proxy server after the URL transmitting module transmits the URL, and render content of the DOM tree structure on the page; wherein the DOM tree structure is obtained by the proxy server by converting a HTML file of the page returned from the Internet server.

17. The method according to claim 2, wherein the script code is a JavaScript code or a VBScript code.

18. The method according to claim 3, wherein the script code is a JavaScript code or a VBScript code.

19. The system according to claim 8, wherein the script code is JavaScript code or VBScript code.

20. The system according to claim 9, wherein the script code is JavaScript code or VBScript code.

21. The system according to claim 10, wherein the script code is JavaScript code or VBScript code.

22. The proxy server according to claim 13, wherein the script code is a JavaScript code or a VBScript code.
